(19) United States
(12) Patent Application Publication
(10) Pub. No.: US 2016/0090920 A1
(43) Pub. Date: Mar. 31, 2016

(54) CONTROLLER SELECTION OF ENGINE BRAKE ACTIVATION TYPE

(71) Applicant: International Engine Intellectual Property Company, LLC, Lisle, IL (US)

(72) Inventors: Askin Minaz, Aurora, IL (US); David William Slessor, Littleton, CO (US); Benjamin Edward Moeggenberg, Jonesville, MI (US); Ly V. Tran, Carol Stream, IL (US)

(21) Appl. No.: 14/496,395

(22) Filed: Sep. 25, 2014

(51) Int. Cl. F02D 13/04

(52) U.S. Cl. CPC F02D 13/04

(57) ABSTRACT

Grade of road on which a motor vehicle travels and load imposed on the vehicle's engine are used to select one of two types of activation for an engine brake.

### TECHNICAL FIELD

The disclosed subject matter relates to a motor vehicle, such as a truck vehicle, which is propelled by an internal combustion engine which has an engine brake.

### BACKGROUND

Some internal combustion propulsion engines of motor vehicles, such as diesel engines, typically run unthrottled. In an unthrottled diesel engine, air from an intake manifold enters through an open cylinder intake valve of a respective engine cylinder into the cylinder during an intake downstroke of a piston which reciprocates within the cylinder. The piston is coupled by a connecting rod to a crankshaft of the engine which is in turn coupled through a drivetrain to drive wheels which propel a motor vehicle.

As the engine cycle for a cylinder transitions from an intake downstroke to a compression upstroke, the cylinder intake valve operates from open to closed. Because a cylinder exhaust valve remains closed during the piston's compression upstroke, intake valve closing causes a volume of air which has entered the cylinder during the piston downstroke to be trapped in the cylinder. As the piston upstrokes, it compresses the trapped volume of air, elevating the air's temperature in the process. When diesel fuel is injected into the cylinder at or near engine top dead center (TDC), it is ignited by the hot compressed air to run the engine and propel the vehicle.

When a driver of the vehicle releases the vehicle's accelerator pedal, the engine ceases to deliver torque to the vehicle's drive wheels and instead, rotation of the drive wheels acting through the vehicle's drivetrain uses kinetic energy of the moving vehicle to compress the trapped air. Some of the energy used to compress the air is recovered as the compressed air expands during an ensuing downstroke, but over an engine cycle, the effect is to decelerate the vehicle.

An engine which has a compression release braking mechanism, sometimes simply called a compression release brake, functions to release the hot air which has been compressed by an engine piston during a compression upstroke into an exhaust manifold of the engine by opening a cylinder exhaust valve at or near TDC. Release of the hot compressed air prevents its energy of expansion from being used during an ensuing downstroke to oppose engine braking

When activated after a driver of a moving vehicle has released the accelerator pedal, a compression release brake enables an engine to provide a significant increase in vehicle deceleration when compared with deceleration which would occur without compression release braking

Therefore, when a motor vehicle is in motion after having been accelerated by its engine, and a driver of the vehicle releases the accelerator pedal while the drive wheels of the vehicle continue to be coupled to the engine through the vehicle's drivetrain, the engine begins to act as a brake by becoming a load which is driven by the drive wheels acting through the drivetrain, and as a result, the vehicle decelerates. If the engine has a compression release brake, the vehicle will decelerate more quickly when the compression release brake is activated. Several configurations for compression release brake activation are known.

One configuration comprises an on-off switch which can be operated by a driver for activating and de-activating the compression release brake.

Another configuration is activation of the compression release brake upon the driver releasing the accelerator control pedal.

Still another configuration is activation of the compression release brake upon the driver depressing a service brake pedal after having released the accelerator pedal.

A selector switch may be used to enable particular sets of engine cylinders to be selected for engine braking

### SUMMARY

One general aspect of the disclosed subject matter relates to a motor vehicle comprising an internal combustion engine which is accelerated by a driver of the vehicle depressing an accelerator pedal to deliver torque through a drivetrain to drive wheels to propel the vehicle along an underlying road surface, and service brakes which are applied by the driver depressing a brake pedal to brake the vehicle.

The engine comprises cylinders within which pistons reciprocate to propel the vehicle by delivering torque to the drive wheels when fuel is being combusted within the cylinders, but when the engine is not delivering torque to the drive wheels as the vehicle travels on an underlying road surface, the drive wheels act through the drivetrain to apply torque to the engine.

The engine further comprises an intake system through which air enters the cylinders to support combustion, an exhaust system through which exhaust resulting from combustion leaves the cylinders, and an engine brake.

When the drive wheels act through the drivetrain to reciprocate the pistons, activation of the engine brake dissipates energy of air which a respective piston has compressed within at least one cylinder during an upstroke by causing the compressed air to be released into the exhaust system rather than to expand during an ensuing downstroke.

A controller enables activation of the engine brake to occur in a selected one of multiple activation types which include an activation type in which an algorithm is repeatedly executed to select between Service Brake Latched Engine Brake activation and Latched Engine Brake activation.

The foregoing summary is accompanied by further detail of the disclosure presented in the Detailed Description below with reference to the following drawings which are part of the disclosure.

### BRIEF DESCRIPTION OF THE DRAWINGS

FIG. 1 schematically shows a truck vehicle having an internal combustion propulsion engine which has a compression release engine brake.

FIG. 2 is a diagram of an algorithm for selecting between Service Brake Latched Engine Brake activation and Latched Engine Brake activation.

FIG. 3 is a general software strategy diagram for a portion of an engine controller.

FIG. 4 shows sub-strategies of FIG. 3.

FIG. 5 is a detailed diagram of a first sub-strategy.

FIG. 6 is a detailed diagram of a second sub-strategy.

FIG. 7 is a detailed diagram of a third sub-strategy.

### DETAILED DESCRIPTION

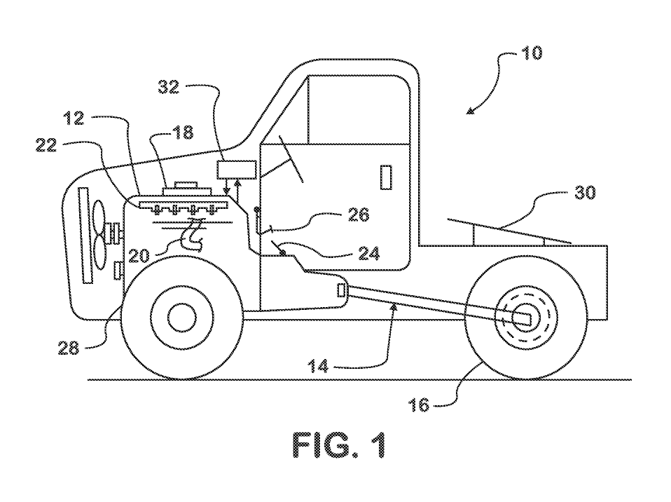

FIG. 1 shows a truck vehicle 10 which is propelled by a multi-cylinder internal combustion engine 12, a diesel engine for example, operating to deliver torque through a drivetrain 14 to rear drive wheels 16.

Engine 12 has a number of cylinders into which fuel is injected by fuel injectors to combust with air which has entered the cylinders through an intake system 18. Exhaust resulting from combustion leaves the cylinders through an exhaust system 20.

Pistons reciprocate within the cylinders to propel truck vehicle 10 by delivering torque to drive wheels 16 through drivetrain 14 when fuel is being combusted within the cylinders, but when engine 12 is not delivering torque to drive wheels 16 as truck vehicle 10 travels on an underlying road surface, the vehicle is decelerated by drive wheels 16 acting through drivetrain 14 to apply torque to engine 12 using kinetic energy of the moving truck vehicle.

Engine 12 also has a compression release engine brake 22. When the rotating drive wheels 16 act through drivetrain 14 to decelerate truck vehicle 10, activation of compression release engine brake 22 dissipates energy of air which a respective piston has compressed within at least one cylinder by causing air which the respective piston has compressed during an upstroke to be released into exhaust system 20 rather than to expand during an ensuing downstroke during which the energy of expansion would counteract the torque being applied to the engine by drive wheels 16. In that way activation of compression release engine brake 22 enables engine 12 to be more efficient as a brake for decelerating truck vehicle 10.

Engine 12 is accelerated by a driver of truck vehicle 10 depressing an accelerator pedal 24 of an engine accelerator. Truck vehicle 10 has a brake pedal 26 which a driver depresses to operate foundation brakes of a service brake system at drive wheels 16 and at front steered wheels 28.

The example illustrated by truck vehicle 10 is that of a highway tractor having a fifth wheel 30 to which a trailer (not shown) can be coupled for towing by truck vehicle 10.

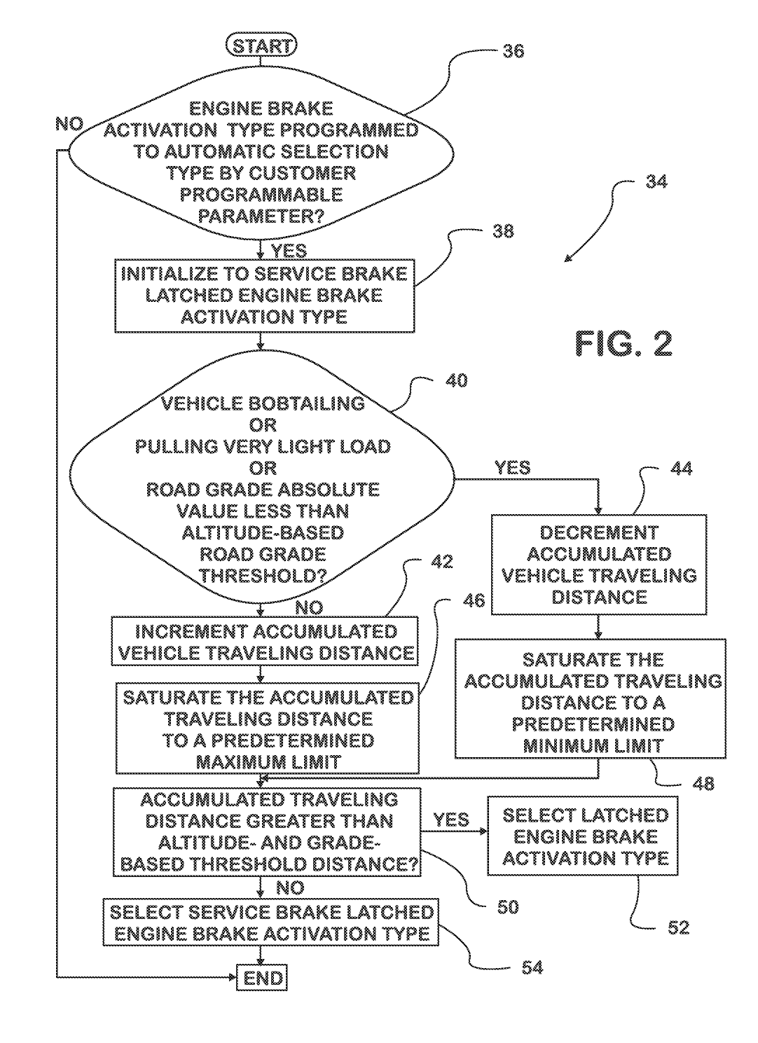

A controller 32 which may be contained in an engine electronic control unit (engine ECU) comprises an executable algorithm 34 (FIG. 2) which selects one of two types of activation for compression release engine brake 22. Those two types are: Service Brake Latched Engine Brake activation and Latched Engine Brake activation.

Latched Engine Brake activation activates compression release engine brake 22 upon release of accelerator pedal 24.

Service Brake Latched Engine Brake activation activates compression release engine brake 22 upon depression of brake pedal 26 after accelerator pedal 24 has been released.

Algorithm 34 represents one of several selectable options for engine brake activation. Each option is uniquely identified by a particular value of a programmable parameter in controller 32. The particular one of the options which is enabled is selected by programming its unique value in controller 32. A user of truck vehicle 10, such as a customer who has purchased the vehicle from a manufacturer or manufacturer's agent, can perform the programming by a user input.

When executed, algorithm 34 first determines if it is has been selected for enablement (Step 36 in FIG. 2). If it has been selected, it will then automatically select between Service Brake Latched Engine Brake activation and Latched Engine Brake activation as the algorithm repeatedly iterates while truck vehicle 10 is being driven.

If Step 36 determines that a different option has been selected, algorithm 34 ceases to execute further until its next iteration.

However if Step 36 determines that the automatic selection option between Latched Engine Brake activation and Service Brake Latched Engine Brake activation has been programmed in controller 32, algorithm 34 continues to execute by performing a Step 38 which initializes Service Brake Latched Engine Brake activation as an initial default setting.

Algorithm 34 then continues by executing a Step 40 which evaluates the load on engine 12 and the grade of the road on which truck vehicle 10 is traveling. Certain conditions such as bobtailing and total vehicle weight, including that of any towed vehicle, affect the load on engine 12. Weight (i.e. mass) of truck vehicle 10, including that of any towed vehicle, is one example of a parameter indicative of load on engine 12. That weight is used in the example described here. The absolute value of the grade of the road on which truck vehicle 10 is traveling is evaluated with respect to a road grade threshold which is itself a function of the elevation relative to sea level (altitude) of truck vehicle 10. Environmental barometric pressure is an example of a parameter which may be used for measuring elevation, and is used as the present example. Using the absolute value of road grade accounts for both uphill and downhill grades.

Only if Step 40, by answering NO, determines that both a) vehicle mass is greater than a vehicle mass threshold and b) grade of road on which truck vehicle 10 is traveling is greater than the road grade threshold, is a total vehicle traveling distance accumulator then incremented (Step 42 in FIG. 2). If Step 40, by answering YES, determines otherwise, the total vehicle traveling distance accumulator is decremented (Step 44 in FIG. 2).

A Step 46 which follows Step 42 sets an upper limit on total accumulated vehicle traveling distance. A Step 48 which follows Step 44 sets a lower limit on total accumulated vehicle traveling distance.

After any incrementing or decrementing of total accumulated vehicle traveling distance, a Step 50 is performed. Step 50 evaluates the total accumulated vehicle traveling distance with respect to a total accumulated traveling distance threshold which is itself a function both of elevation of truck vehicle 10 relative to sea level and of grade of road on which truck vehicle 10 is traveling (i.e. is both altitude- and road grade-based). The result of the evaluation is used to select between Latched Engine Brake activation (reference numeral 52) and Service Brake Latched Engine Brake activation (reference numeral 54).

The algorithm repeatedly iterates at an appropriate iteration rate as truck vehicle 10 travels along a road. Total accumulated vehicle traveling distance incrementally accumulates provided that the vehicle is traveling on uphill and downhill road grades whose absolute values are greater than the road grade threshold and that vehicle mass is concurrently greater than the vehicle mass threshold. Otherwise, total accumulated vehicle traveling distance decrements, such as during travel on relatively flat ground (less than road grade threshold) or at light engine load (less than engine load threshold).

Total accumulated vehicle traveling distance is compared with the total vehicle traveling distance threshold which is different at different elevations. When total accumulated vehicle traveling distance is not greater than the vehicle traveling distance threshold (answer NO to Step 50), the initialized Service Brake Latched Engine Brake activation continues as the engine brake activation type. When total accumulated vehicle traveling distance is greater than the total vehicle traveling distance threshold (answer YES to Step 50), the initialized Service Brake Latched Engine Brake activation is discontinued and is replaced by Latched Engine Brake activation.

Road grade and vehicle weight can be provided by any suitable source such as a transmission control module or an alternative control module like smart cruise.

By automatically configuring engine brake activation based on road grade and on engine load, as measured by vehicle weight as in the present example, a vehicle may exhibit better driving performance and better overall fuel economy. Faster brake activation (Latched Engine Brake activation) will occur automatically when a vehicle is operating in situations which call for it because there is no delay due to the driver moving the foot from the accelerator pedal to the brake pedal. In other situations after the accelerator pedal has been released, it may be premature to activate the engine brake, and so engine brake activation by depressing the brake pedal is left to the discretion of the driver (Service Brake Latched Engine Brake activation).

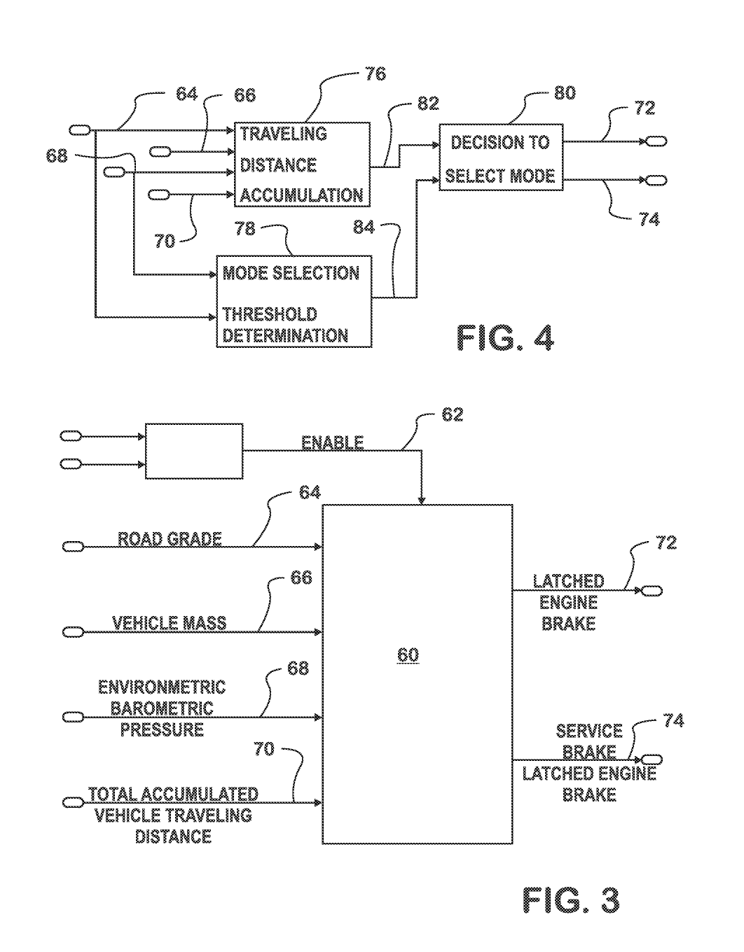

FIGS. 3-7 present detail of a software strategy 60 which implements algorithm 34. FIG. 3 shows that data inputs are an enable input 62, a road grade input 64, a vehicle mass input 66, an environmental barometric pressure input 68, and a total accumulated vehicle traveling distance input 70. Data outputs are a Latched Engine Brake activation output 72 and a Service Brake Latched Engine Brake activation output 74. Enable input 62 enables algorithm 34 to be the option selected for engine brake activation by the programmable parameter. Type of transmission in a vehicle may sometimes be a factor in enabling algorithm 34. Hence, when algorithm 34 is selected by the proper programmable parameter and a compatible transmission type is also selected, algorithm 34 is enabled.

FIG. 4 shows software strategy 60 to comprise a Traveling Distance Accumulation sub-strategy 76, a Mode Selection Threshold Determination sub-strategy 78, and a Decision To Select Mode sub-strategy 80.

Road grade input 64, vehicle mass input 66, environmental barometric pressure input 68, and total accumulated vehicle traveling distance input 70 are inputs to Traveling Distance Accumulation sub-strategy 76.

Road grade input 64 and environmental barometric pressure input 68 are inputs to Mode Selection Threshold Determination sub-strategy 78.

An output 82 of Traveling Distance Accumulation sub-strategy 76 and an output 84 of Mode Selection Threshold Determination sub-strategy 78 are inputs to Decision To Select Mode sub-strategy 80.

Decision To Select Mode sub-strategy 80 provides the two outputs, Latched Engine Brake activation output 72 and Service Brake Latched Engine Brake activation output 74.

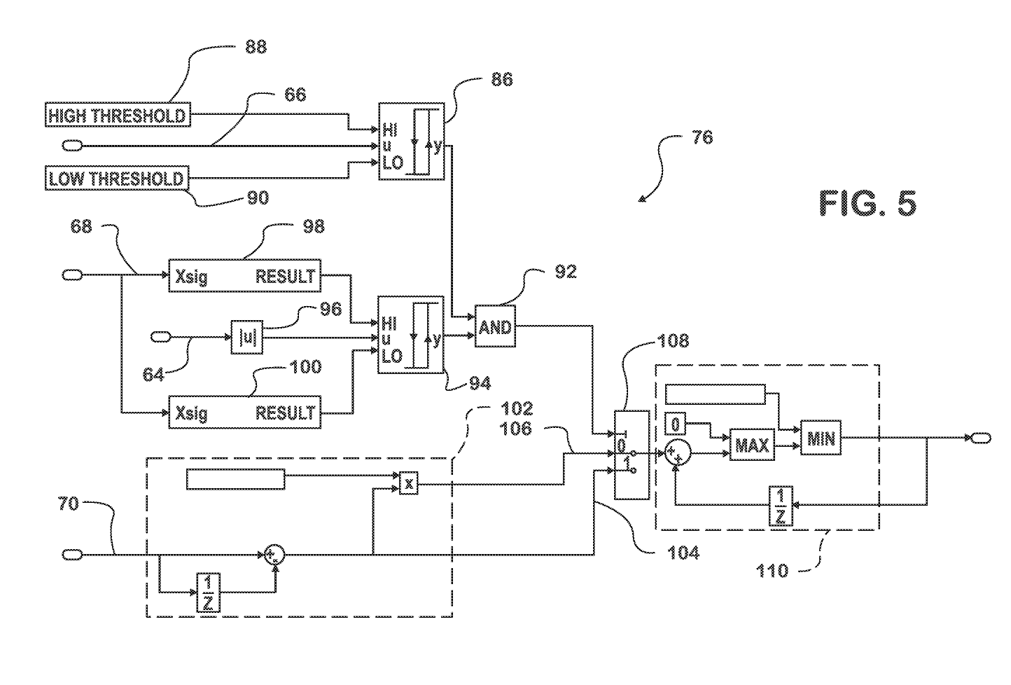

FIG. 5 shows detail of Traveling Distance Accumulation sub-strategy 76. A logic function 86 evaluates vehicle mass data at input 66 with respect to a vehicle mass threshold, which is defined by a range which lies between a high threshold 88 and a low threshold 90. When vehicle mass becomes greater than high threshold 88, logic function 86 outputs a logic “1”. When vehicle mass becomes less than low threshold 90, logic function 86 outputs a logic “0”. This provides hysteresis which avoids occasional excessively frequent switching of the output which might otherwise occur if a single value were used for the vehicle mass threshold.

The output of logic function 86 is one input to a two-input AND logic function 92. The other input to function 92 is an output of a logic function 94 which evaluates environmental barometric pressure data at input 68 and road grade data at input 64.

Because a measurement of road grade may be either positive or negative, its absolute value is determined by an absolute value function 96 and that is then used by logic function 94 to select an output from either a first look-up table 98 which is based on larger absolute values of road grade or a second look-up table 100 which is based on smaller absolute values of road grade.

Each look-up table is populated with binary logic values (i.e. “1” and “0”) representing a population of altitude-compensated road grades some of which (logic value “1”) have been predetermined as being sufficiently steep to call for total accumulated vehicle traveling distance to be incremented and the remainder of which (logic value “0”) not to call for total accumulated vehicle traveling distance to be incremented.

AND logic function 92 consequently provides a logic “1” output only when both an altitude-compensated road grade is greater than an altitude-compensated road grade threshold and vehicle mass is greater than a vehicle mass threshold. Otherwise, AND logic function 92 provides a logic “0” output. When AND logic function provides a logic “1” output, total accumulated vehicle traveling distance is incremented, and when AND logic function provides a logic “0” output, total accumulated vehicle traveling distance is decremented.

An incrementer/decrementer 102 provides both an increment input 104 and a decrement input 106 to a selection function 108. Function 108 selects the increment input to cause an increment to be added to total accumulated vehicle traveling distance when AND logic function 92 is providing a logic “1” output, and selects the decrement input to cause a decrement to be subtracted from total accumulated vehicle traveling distance when AND logic function 92 is providing a logic “0” output.

A limiting function 110 stops further incrementing of total accumulated vehicle traveling distance when total accumulated vehicle traveling distance equals a positive upper accumulation limit and also stops further decrementing when total accumulated vehicle travel distance equals a lower accumulation limit such as zero, thereby preventing the total accumulated vehicle traveling distance from becoming a negative number. The output of sub-strategy 76 thereby becomes the total accumulated vehicle travel distance which will be provided at input 70 when algorithm 34 next iterates.

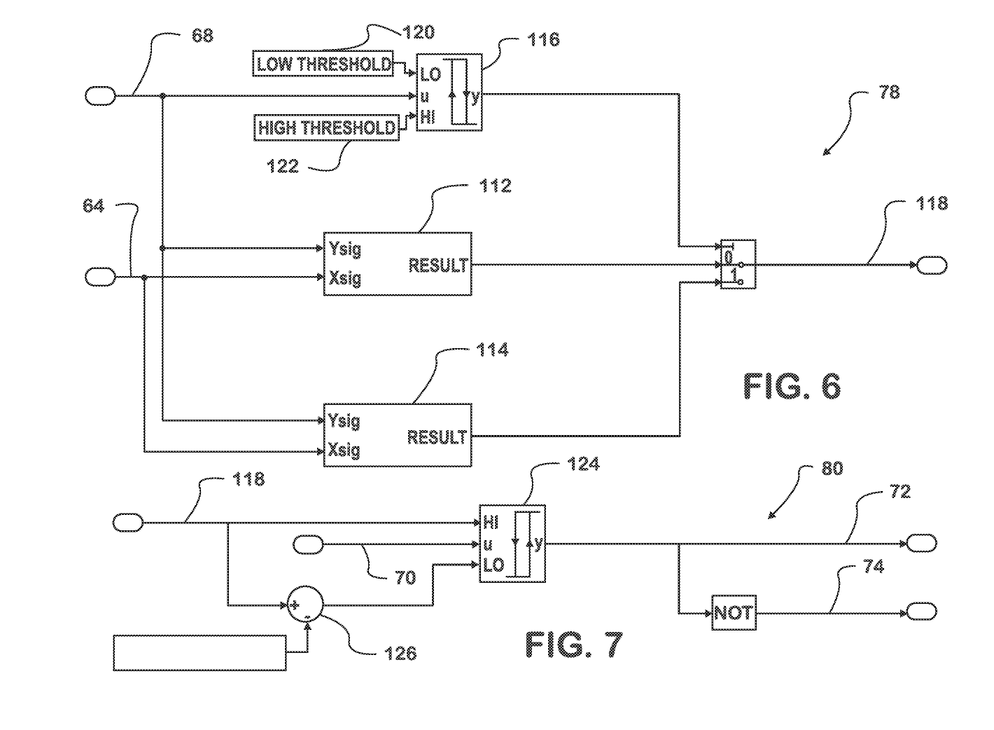

FIG. 6 shows detail of Mode Selection Threshold Determination sub-strategy 78. A look-up table 112 contains a correlation of each of various combinations of environmental barometric pressures and road grades with a value of total accumulated vehicle traveling distance threshold. The environmental barometric pressures in table 112 span a range typical of a low altitude range where pressure is high.

A look-up table 114 contains a correlation of each of various combinations of environmental barometric pressures and road grades with a value of total accumulated vehicle distance traveling threshold. The environmental barometric pressures in table 114 span a range typical of a high altitude range where pressure is low.

The value of environmental barometric pressure data at input 68 is used by a logic function 116 to select the appropriate look-up table 112 or 114 to provide a total accumulated vehicle traveling distance threshold at an output 118.

Logic function 116 evaluates environmental barometric pressure data at input 68 with respect to an environmental barometric pressure threshold, which is defined by a range which lies between a Low Pressure Threshold 120 and a High Pressure Threshold 122. When environmental barometric pressure becomes greater than High Pressure Threshold 122, logic function 116 outputs a logic “0”. When environmental barometric pressure becomes less than Low Pressure Threshold 120, logic function 116 outputs a logic “1”. This provides hysteresis which avoids occasional excessively frequent switching of the output which might occur if a single value were used for the environmental barometric pressure threshold. Hence, when environmental barometric pressure becomes less than Low Pressure Threshold 120, table 114 is used, and when environmental barometric pressure becomes greater than High Pressure Threshold 122, table 112 is used.

FIG. 7 shows detail of Decision To Select Mode sub-strategy 80. A selection function 124 evaluates accumulated vehicle traveling distance data at input 70 with respect to the accumulated vehicle traveling distance threshold provided at output 118. The result selects either Service Brake Latched Engine Brake activation or Latched Engine Brake activation by providing the appropriate output 72, 74 to controller 32 so that engine braking will be activated accordingly. When the accumulated vehicle traveling distance becomes greater than the accumulated vehicle traveling distance threshold, Latched Engine Brake activation is selected by a logic “1” at the output of function 124. When the accumulated vehicle traveling distance becomes less than the accumulated vehicle traveling distance threshold, Service Brake Latched Engine Brake activation is selected by a logic “0” at the output of function 124 which is logically inverted to provide a logic “1” at output 74. Algorithm 34 may provide an option for the accumulated vehicle traveling distance to be reset when 12 engine is off. The inclusion of a hysteresis function 126 avoids excessively frequent switching between the two types of activation. When algorithm 34 is not enabled, outputs 72 and 74 are both forced to logic “0”.

A global vehicle distance accumulator determines whether truck vehicle 10 is traveling and measures accumulated distance traveled. Accumulated vehicle traveling distance is calculated based on vehicle speed, software execution time, and some metric unit conversion constant. The front end of Traveling Distance Accumulation sub-strategy 76 embodies an internal distance accumulator which increments on the basis of distance traveled between iterations of algorithm 34 when both vehicle mass is greater than the vehicle mass threshold and road grade is greater than the road grade threshold.

What is claimed is:

1. A motor vehicle comprising:
an internal combustion engine which, when operated by a driver of the vehicle depressing an accelerator pedal, delivers torque through a drivetrain to drive wheels which propel the vehicle along an underlying road surface, and service brakes which, when operated by the driver depressing a brake pedal, brake the vehicle;
the engine comprising cylinders within which combustion of fuel reciprocates a respective piston which causes torque to be applied through the drivetrain to the drive wheels to propel the vehicle, but when the engine is not applying torque to the drive wheels as the vehicle travels along an underlying road surface, the vehicle is decelerated by the drive wheels acting through the drivetrain to apply torque to the engine using kinetic energy of the moving vehicle;
the engine further comprising an intake system through which air enters the cylinders to support combustion and an exhaust system through which exhaust resulting from combustion leaves the cylinders;
an engine brake which, when the drive wheels act through the drivetrain to apply torque to the engine, can be activated to dissipate energy of air which a respective piston has compressed within at least one cylinder during an upstroke by causing the compressed air to be released into the exhaust system rather than to expand during an ensuing downstroke;
and a controller for enabling activation of the engine brake to occur in a selected one of multiple activation types which include an activation type in which an algorithm is repeatedly executed to select between service brake latched engine brake activation and latched engine brake activation.

2. The motor vehicle as set forth in claim 1 in which the algorithm's selection between service brake latched engine brake activation and latched engine brake activation is initially selected to be service brake latched engine brake activation and subsequently selected as a result of the algorithm's processing of data about at least one of grade of road on which the vehicle travels and load on the engine.

3. The motor vehicle as set forth in claim 2 in which the algorithm's subsequent selection between service brake latched engine brake activation and latched engine brake activation is made as a result of the algorithm's processing of data about both grade of road on which the vehicle travels and load on the engine, and data about at least one additional parameter.

4. The motor vehicle as set forth in claim 3 in which as the vehicle is traveling, execution of the algorithm selectively increments and decrements an accumulated vehicle traveling distance as a function of both grade of road on which the vehicle travels and load on the engine.

5. The motor vehicle as set forth in claim 4 in which execution of the algorithm evaluates the accumulated vehicle traveling distance relative to an accumulated vehicle traveling distance threshold and causes latched engine brake activation to be selected when the accumulated vehicle traveling distance becomes greater than the accumulated vehicle traveling distance threshold.

6. The motor vehicle as set forth in claim 5 in which the at least one additional parameter is the vehicle's elevation above sea level.

7. The motor vehicle as set forth in claim 6 in which execution of the algorithm selects a first value for the accumulated vehicle traveling distance threshold when elevation of the vehicle is within a first range above sea level and a second value for the accumulated vehicle traveling distance threshold when elevation of the vehicle is within a second range above sea level.

8. The motor vehicle as set forth in claim 5 in which execution of the algorithm stops further incrementing of the accumulated vehicle traveling distance when the accumulated vehicle traveling distance equals an upper accumulation limit and also stops further decrementing of the accumulated vehicle traveling distance when the accumulated vehicle traveling distance equals a lower accumulation limit.

9. The motor vehicle as set forth in claim 5 in which the algorithm causes the accumulated vehicle traveling distance to be incremented when both load imposed on the engine is greater than an engine load threshold and grade of road on which the vehicle travels is greater than absolute value of a road grade threshold, and the algorithm causes the accumulated vehicle traveling distance to be decremented when either load on the engine becomes less than the engine load threshold or absolute value of grade of road on which the vehicle travels becomes less than the road grade threshold.

10. The motor vehicle as set forth in claim 9 in which execution of the algorithm selects a first value for road grade threshold when elevation of the vehicle is within a first range above sea level and a second value for road grade threshold when elevation of the vehicle is within a second range above sea level.

11. The motor vehicle as set forth in claim 9 in which load on the engine is measured by mass of the vehicle, including that of any other vehicle being towed.

12. The motor vehicle as set forth in claim 1 in which a particular one of the multiple activation types is selected by a programmable parameter in the controller.

13. The motor vehicle as set forth in claim 4 in which the algorithm provides an option for the accumulated vehicle traveling distance to be reset when the engine is off.
